(19) United States
(12) Patent Application Publication
(10) Pub. No.: US 2005/0062866 A1
(43) Pub. Date: Mar. 24, 2005

(54) Multiplexed pixel column architecture for imagers

(76) Inventor: Lin Ping Ang, Chino Hills, CA (US)

Correspondence Address: DICKSTEIN SHAPIRO MORIN & OSHINSKY LLP, 2101 L Street, NW, Washington, DC, 20037, US

(21) Appl. No.: 10/667,394

(22) Filed: Sep. 23, 2003

(51) Int. Cl. H04N 3/14; H04N 5/335

(52) U.S. Cl. 348/302

(57) ABSTRACT

An imager with a multiplexer located at the pixel output line connected to associated column sample and hold circuitry. The multiplexer ensures that signals from pixels within a column are output to the correct output channels in the readout path. By having the multiplexer at the pixel output line, before any sample and hold circuitry, the imager can use simplified column select circuitry when signals are being read out to the output channels. As such, parasitic capacitance at the readout path is reduced, which produces faster readout speeds than typical imagers. In addition, the imager achieves lower readout noise and less power consumption than typical imagers.

### FIELD OF THE INVENTION

The invention relates generally to imaging devices, and more particularly to an imager with a multiplexed pixel column architecture.

### BACKGROUND

Imaging devices such as complementary metal oxide semiconductor (CMOS) imagers are commonly used in photo-imaging applications.

A CMOS imager circuit includes a focal plane array of pixel cells, each one of the cells including either a photogate, photoconductor or a photodiode overlying a substrate for accumulating photo-generated charge in the underlying portion of the substrate. A readout circuit is connected to each pixel cell and includes at least an output field effect transistor formed in the substrate and a charge transfer section formed on the substrate adjacent the photogate, photoconductor or photodiode having a sensing node, typically a floating diffusion node, connected to the gate of an output transistor. The imager may include at least one electronic device such as a transistor for transferring charge from the underlying portion of the substrate to the floating diffusion node and one device, also typically a transistor, for resetting the node to a predetermined charge level prior to charge transference.

In a CMOS imager, the active elements of a pixel cell perform the necessary functions of: (1) photon to charge conversion; (2) accumulation of image charge; (3) transfer of charge to the floating diffusion node accompanied by charge amplification; (4) resetting the floating diffusion node to a known state before the transfer of charge to it; (5) selection of a pixel for readout; and (6) output and amplification of a signal representing pixel charge. Photo charge may be amplified when it moves from the initial charge accumulation region to the floating diffusion node. The charge at the floating diffusion node is typically converted to a pixel output voltage by a source follower output transistor. The photosensitive element of a CMOS imager pixel is typically either a depleted p-n junction photodiode or a field induced depletion region beneath a photogate. For photodiodes, image lag can be eliminated by completely depleting the photodiode upon readout.

CMOS imagers of the type discussed above are generally known as discussed, for example, in U.S. Pat. No. 6,140,630, U.S. Pat. No. 6,376,868, U.S. Pat. No. 6,310,366, U.S. Pat. No. 6,326,652, U.S. Pat. No. 6,204,524 and U.S. Pat. No. 6,333,205, assigned to Micron Technology, Inc., which are hereby incorporated by reference in their entirety.

A typical CMOS imager 10 is illustrated in FIG. 1. The imager 10 includes a pixel array 20 connected to column sample and hold (S/H) circuitry 30. The pixel array 20 comprises a plurality of pixels arranged in a predetermined number of rows and columns. In operation, the pixels of each row in the array 20 are all turned on at the same time by a row select line and the pixels of each column are selectively output by a column select line. A plurality of row and column lines are provided for the entire array 20.

The row lines are selectively activated by row decoder and driver circuitry (not shown) in response to an applied row address. The column select lines are selectively activated by column decoder and driver circuitry contained within the column sample and hold circuitry 30 in response to an applied column address. Thus, a row and column address is provided for each pixel. The CMOS imager 10 is operated by a control circuit (not shown), which controls the row and column circuitry for selecting the appropriate row and column lines for pixel readout.

The CMOS imager 10 illustrated in FIG. 1 uses a dual channel readout architecture. That is, the imager 10 includes a first channel Chg and a second channel Chrb for pixel and reset signals read out of the array 20. Each readout channel Chg, Chrb is used to read out half the number of pixels connected to the column S/H circuitry 30. As is known in the art, once read out, the analog reset and pixel signals pass through an amplifier, gain stage and an analog-to-digital converter (ADC) before being processed as digital signals by an image processor. Since each channel Chg, Chrb contains its own readout amplifier, gain stage, and ADC, there exists an offset and slight gain difference due to process mismatches.

Many imagers use the Bayer color filter array (CFA) scheme for its pixel arrays. FIG. 2 illustrates the Bayer scheme for the pixel array 20 illustrated in FIG. 1. Each row of pixels contains two types of CFA's. Row0, for example, contains alternating green 22 (designated as Gr) and red 24 (designated as R) pixels, while Row1 contains alternating blue 26 (designated as B) and green 28 (designated as Gb) pixels. To ensure that the green pixels 22, 28 (Gr, Gb) have the same offset and gain, the signals from the green pixels need to be transferred from the column S/H circuitry 30 to the same channel, e.g., Chg. Therefore, the first channel Chg will readout the signals from the green pixels 22, 28 (Gr, Gb) while the second channel Chrb will readout the signals from the red and blue pixels 24, 26 (R, B).

FIG. 3 is a circuit diagram of the imager 10 illustrated in FIG. 1. The pixel array 20 comprises M rows and N columns. As can be seen in FIG. 3, the column S/H circuitry 30 comprises multiple column S/H sub-circuits 30₀, 30₁, . . . 30ₙ₋₁, one for each column in the array 20. Each sub-circuit 30₀, 30₁, . . . 30ₙ₋₁ is respectively connected to a pixel output line pixout0, pixout1, . . . pixoutn−1. The first output channel Chg includes two output lines 70, 72. The second output channel Chrb contains two output lines 74, 76. During operation of the imager 10, the pixel output lines pixout0, pixout1, . . . , pixoutn−1 carry reset and pixel signals from their respective associated pixels in the array 20.

The column decoder 18 provides a column 0 select signal colse10, column 0 green pixel select signal colse10_g, and a column 0 red/blue select signal colse10_rb to the column 0 (first) S/H sub-circuit 30₀. Similarly, the column decoder 18 provides a column 1 select signal colse11, column 1 green pixel select signal colse11_g, and a column 1 red/blue select signal colse11_rb to the column 1 (second) S/H sub-circuit 30₁. A global crowbar control signal CB, sample and hold pixel control signal SHS and a sample and hold reset control signal SHR are also provided to the column S/H sub-circuits 30₀, 30₁, . . . 30ₙ₋₁. The use of these signals CB, SHS, SHR are described below in more detail.

The global crowbar control signal CB is input into an AND gate 38₀ of the column 0 S/H sub-circuit 30₀. The second input of the AND gate 38₀ is connected to the column 0 select signal colse10. The output of the AND gate 38₀ is a crowbar control/select column 0 signal CBse10, which is generated only when the colse10 and CB signals are activated at the same time.

The column 0 S/H sub-circuit 30₀ also comprises a biasing transistor 32₀, controlled by a control voltage Vln, that is used to bias its respective pixel output line pixout0. The pixel output line pixout0 is also connected to a first capacitor 42₀ thru a sample and hold pixel signal switch 34₀. The sample and hold pixel signal switch 34₀ is controlled by the sample and hold pixel control signal SHS. In addition, the pixel output line pixout0 is connected to a second capacitor 44₀ thru a sample and hold reset signal switch 36₀. The sample and hold reset signal switch 36₀ is controlled by the sample and hold reset control signal SHR The switches 34₀, 36₀ are typically MOSFET transistors.

A second terminal of the first capacitor 42₀ is connected to the first red/blue pixel output line 74 via a first column select switch 50₀, which is controlled by the colse10_rb signal. The second terminal of the first capacitor 42₀ is also connected to the first green pixel output line 70 via a second column select switch 52₀, which is controlled by the colse10_g signal. The second terminal of the first capacitor 42₀ is also connected to a clamping voltage VCL via a first clamping switch 60₀.

The second terminal of the second capacitor 44₀ is further connected to the second green pixel output line 72 via a third column select switch 54₀, which is controlled by the colse10_g signal. The second terminal of the second capacitor 44₀ is also connected to the second red/blue pixel output line 76 via a fourth column select switch 56₀, which is controlled by the colse10_rb signal. The second terminal of the second capacitor 44₀ is also connected to the clamping voltage VCL via a second clamping switch 62₀.

The four column select switches 50₀, 52₀, 54₀, 56₀ are part of a multiplexer 58, the operation of which is described below in more detail. The multiplexer 58 also comprises additional column select switches (e.g., 50₁, 52₁, 54₁, 56₁) from the remaining column S/H sub-circuits 30₁, . . . , 30ₙ₋₁. The column select switches 50₀, 52₀, 54₀, 56₀, 50₁, 52₁, 54₁, 56₁ are typically MOSFET transistors.

As is known in the art, the clamping voltage VCL is used to place a charge on the two capacitors 42₀, 44₀ when it is desired to store the pixel and reset signals, respectively from the array 20 (when the appropriate S/H control signals SHS, SHR are also generated).

Connected between the connection of the first capacitor 42₀ and its sample and hold switch 34₀ and the connection of the second capacitor 44₀ and its sample and hold switch 36₀ is a crowbar switch 40₀. The crowbar switch 40₀ is controlled by the CBse10 output from the AND gate 38₀. During readout of column 0, the column 0 S/H sub-circuit 30₀ is selected by the colse10 signal, the global crowbar control signal CB is also generated, which causes the CBse10 signal to be output from the AND gate 38₀. As such, crowbar switch 40₀ is closed, which shorts the front plates of the two capacitors 42₀, 44₀, driving the respective charges on these capacitors 42₀, 44₀ out to the multiplexer 58.

Similar to the column 0 S/H sub-circuit 30₀, the global crowbar control signal CB is input into an AND gate 38₁ of the column 1 S/H sub-circuit 30₁. The second input of the AND gate 38₁ is connected to the column 1 select signal colse11. The output of the AND gate 38₁ is a crowbar control/select column 1 signal CBse11, which is generated only when the colse11 and CB signals are activated at the same time. The remainder of the column 1 S/H sub-circuit 30₁ is essentially the same as the column 0 S/H sub-circuit 30₀. Thus, no further description of the column 1 S/H sub-circuit 30₁ is required.

Assuming that even numbered rows (e.g., Row0, Row2, etc.) have green pixels 22 (Gr) in even numbered columns (e.g., Co10, Co12, etc.) and red pixels 24 in odd numbered columns (e.g., Co11, Co13, etc.), then according to the Bayer CFA pattern, odd rows (e.g., Row1, Row3, etc.) have green pixels 28 (Gb) in the odd numbered columns and blue pixels 26 in the even numbered columns.

Referring to FIGS. 2 and 3, in operation, the signals from the pixels from Row0 are sampled onto the S/H circuitry 30 first. Even numbered column S/H circuitry (e.g., sub-circuit 30₀) will receive the signals from the green pixels 22 (Gr) from Row0. Odd numbered column S/H circuitry (e.g., sub-circuit 30₁) will receive the signals from the red pixels 24 (R) from Row0. To make sure the signals from the Row0 green pixels 22 go to the first channel Chg, and the signals from the red pixels 24 go to the second channel Chrb, the multiplexer 58 described above is included within the column S/H circuitry just prior to the readout lines 70, 72, 74, 76 to the channels Chg, Chrb.

Thus, during the readout operation performed on Row0, the column select switch/transistors 52₀, 54₀ connected to the first channel Chg in each even numbered column (e.g., Co10, Co12, etc.) must be selected in the multiplexer 58. In addition, during the readout operation performed on Row0, the column select switch/transistors 50₁, 56₁ connected to the second channel Chrb in each odd numbered column (e.g., Co11, Co13, etc.) must be selected in the multiplexer 58.

When the Row1 signals are sampled onto the column S/H circuitry 30₀, 30₁, . . . , 30ₙ₋₁, the even numbered columns (e.g., Co10, Co12, etc.) will have the signals from the blue pixels 26 and the odd numbered columns (e.g., Co11, Co13, etc.) will have the signals received from the green pixels 28 (Gb). Thus, during the readout operation performed on Row1, the column select switch/transistors 52₁, 54₁ connected to the first channel Chg in each odd numbered column (e.g., Co11, Co13, etc.) must be selected in the multiplexer 58. In addition, during the readout operation performed on Row1, the column select switch/transistors 50₀, 56₀ connected to the second channel Chrb in each even numbered column (e.g., Co10, Co12, etc.) must be selected in the multiplexer 58.

This complicated multiplexer scheme used in the imager 10 has some drawbacks. For example, the imager 10 has a slower readout than is desired. There is increased parasitic capacitance on the readout path since there are two column select transistors connected to each sample and hold capacitor. More parasitic capacitance means slower readout rates because the readout speed depends upon the parasitic resistance and capacitance. This problem gets worse as the frequency of the switching in the readout path is increased.

The imager 10 also experiences higher readout noise and more power consumption than desired. The extra capacitance on the readout path reduces the feedback factor of an amplifier connected to the channels Chg, Chrb (in a subsequent stage of the imager 10). This increases the overall readout noise since part of the readout noise is inversely proportional to the feedback factor. The speed requirement of the amplifier is also inversely proportional to the feedback factor. Thus, the unit gain frequency of the amplifier needs to be increased. It may be possible to increase the feedback capacitor of the amplifier to improve its feedback factor, but this would cause a much higher power consumption and is also undesirable.

Accordingly, there is a need and desire for a column multiplexing scheme for an imager that ensures that signals from pixels within a column are output to the correct output channels. There is also a need and desire for a column multiplexing scheme for an imager that produces faster readout speeds and lowers readout noise and power consumption.

### SUMMARY

The present invention provides a column multiplexing scheme for an imager that ensures that signals from pixels within a column are output to the correct output channels.

The present invention also provides a column multiplexing scheme for an imager that produces faster readout speeds and lowers readout noise and power consumption.

The above and other features and advantages are achieved in various embodiments of the invention by providing an imager with a multiplexer located at the pixel output line connected to associated column sample and hold circuitry. The multiplexer ensures that signals from pixels within a column are output to the correct output channels in the readout path. By having the multiplexer at the pixel output line, before any sample and hold circuitry, the imager can use simplified column select circuitry when signals are being read out to the output channels. As such, parasitic capacitance at the readout path is reduced, which produces faster readout speeds than typical imagers. In addition, the imager achieves lower readout noise and less power consumption than typical imagers.

### BRIEF DESCRIPTION OF THE DRAWINGS

The foregoing and other advantages and features of the invention will become more apparent from the detailed description of exemplary embodiments provided below with reference to the accompanying drawings in which:

FIG. 1 is a block diagram of a CMOS imager;

FIG. 2 illustrates a pixel array that may be used in the imager of FIG. 1;

FIG. 3 illustrates a circuit diagram of the CMOS imager illustrated in FIG. 1;

FIG. 4 illustrates a circuit diagram of a CMOS imager constructed in accordance with a first exemplary embodiment of the invention;

FIG. 5 illustrates a circuit diagram of a CMOS imager constructed in accordance with a second exemplary embodiment of the invention; and

FIG. 6 shows a processor system incorporating at least one imager device constructed in accordance with an embodiment of the invention.

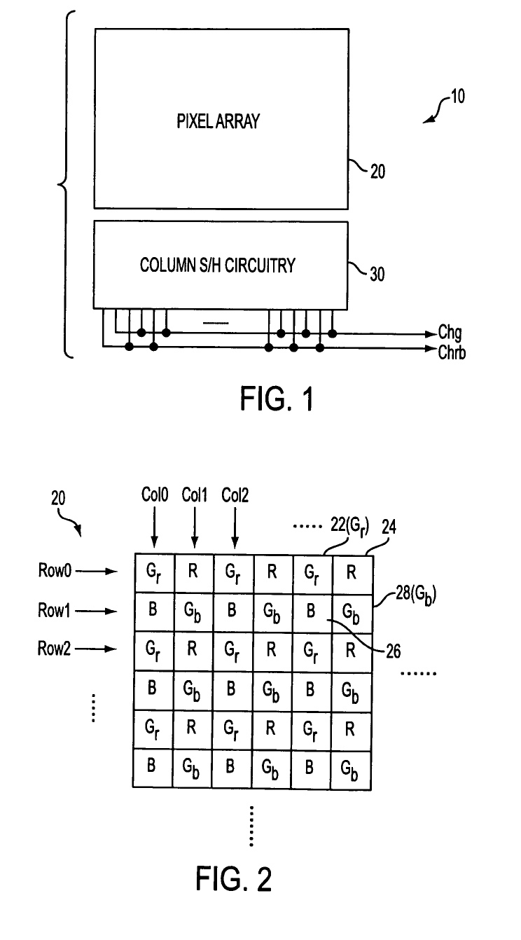

### DETAILED DESCRIPTION

In the following detailed description, reference is made to the accompanying drawings, which are a part of the specification, and in which is shown by way of illustration various embodiments whereby the invention may be practiced. These embodiments are described in sufficient detail to enable those skilled in the art to make and use the invention. It is to be understood that other embodiments may be utilized, and that structural, logical, and electrical changes, as well as changes in the materials used, may be made without departing from the spirit and scope of the present invention.

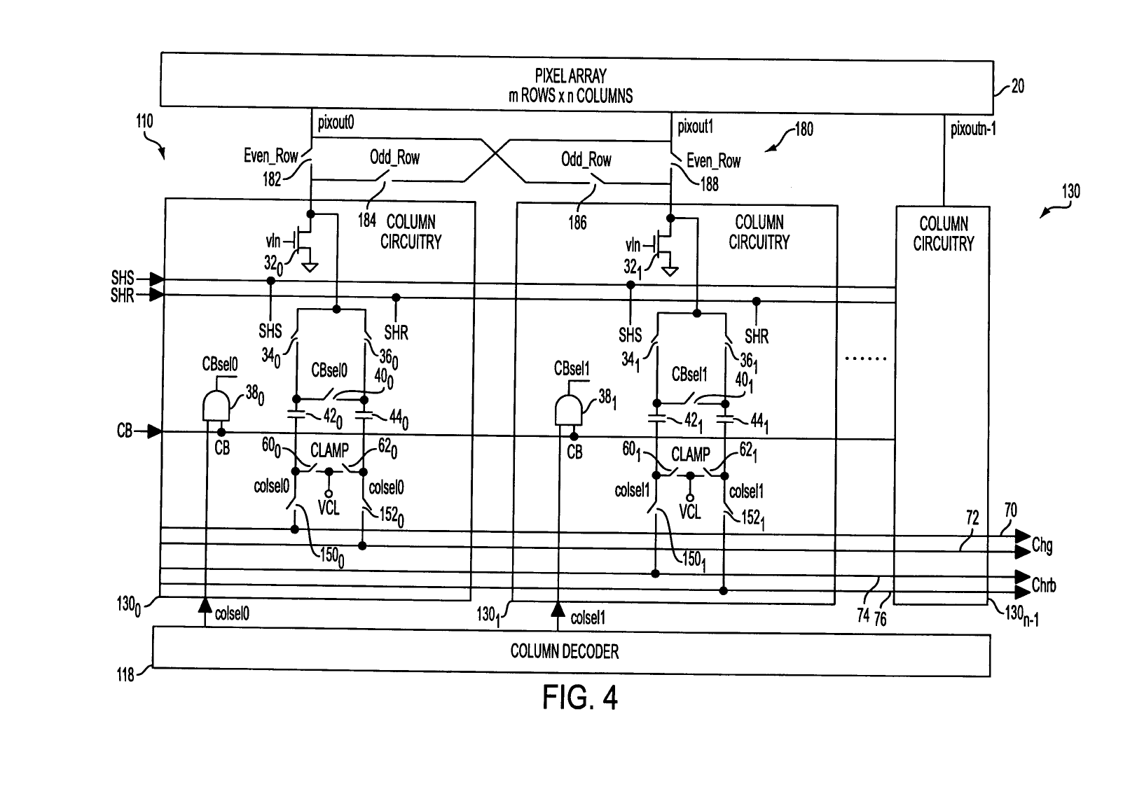

Now referring to the figures, where like reference numbers designate like elements, FIG. 4 shows a CMOS imager 110 constructed in accordance with a first exemplary embodiment of the invention. The imager 110 includes a pixel array 20, column decoder 118, column S/H circuitry 130 and a multiplexer 180. The imager 110 has two output channels Chg, Chrb. The first channel Chg includes two output lines 70, 72. The second channel Chrb includes two output lines 74, 76.

The pixel array 20 comprises M rows and N columns. The column S/H circuitry 130 comprises multiple column S/H sub-circuits 130₀, 130₁, . . . 130ₙ₋₁, one for each column in the array 20. Each sub-circuit 130₀, 130₁, . . . 130ₙ₋₁ is respectively connected to one of two pixel output lines pixout0, pixout1, . . . , pixoutn−1 through the multiplexer 18₀. During operation of the imager 110, the pixel output lines pixout0, pixout1, . . . , pixoutn−1 carry reset and pixel signals from their respective associated pixels in the array 20.

The multiplexer 180 contains circuitry for connecting one even numbered column S/H sub-circuit 130₀ and one odd numbered column S/H sub-circuit 130₁ to one even numbered pixel output line pixout0 and one odd numbered pixel output line pixout1. FIG. 4 illustrates only one portion of the multiplexer 180. It should be appreciated that since the pixel array 20 contains N columns, that the multiplexer 180 would contain enough circuitry to connect each even numbered column S/H sub-circuit and a respective odd numbered column S/H sub-circuit to one even numbered pixel output line and one odd numbered pixel output line. That is, the portion of the multiplexer 180 illustrated in FIG. 4 is repeated throughout the imager 110 for every pair of even numbered and odd numbered column S/H sub-circuits and every associated pair of even numbered and odd numbered pixel output lines.

The illustrated multiplexer 180 comprises a plurality of input switches 182, 184, 186, 188. The first input switch 182 is connected between the pixel 0 pixel output line pixout0 and the column 0 S/H sub-circuit 1300 and is controlled by an even row control signal EVEN_ROW. The even row control signal EVEN_ROW is generated by a controller when even numbered rows are being read during a readout operation. Similarly, the fourth input switch 188 is connected between the pixel 1 pixel output line pixout1 and the column 1 S/H sub-circuit 130₁ and is controlled by the even row EVEN_ROW control signal.

The second and third input switches 184, 186 are connected between the connection of the pixel 0 pixel output line pixout0 and the column 0 S/H sub-circuit 130₀ and the connection of the pixel 1 pixel output line pixout1 and the column 1 S/H sub-circuit 130₁. The second and third input switches 184, 186 are controlled by an odd row control signal ODD_ROW. The odd row control signal ODD_ROW is generated by a controller or processor when odd numbered rows are being read during a readout operation. In a desired embodiment, the switches 182, 184, 186, 188 of the multiplexer 180 are MOSFET transistors. It should be appreciated that the invention may use any suitable controllable switching device as the switches 182, 184, 186, 188, and that the invention is not limited to MOSFET transistors. The operation of the multiplexer 180 is described below in more detail.

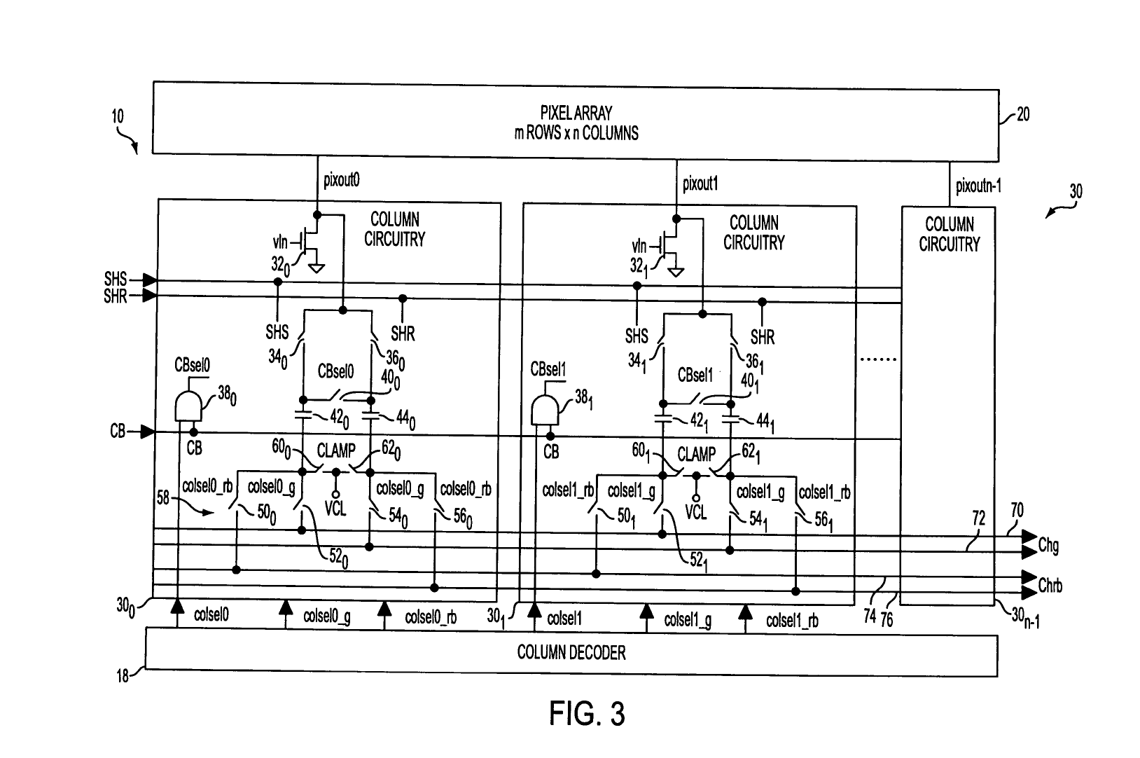

By placing the multiplexer 180 before the column sample and hold circuitry 130, the imager 110 will use a very simple column select scheme (described below in more detail), which means that the imager 110 will also use a simple column decoder 118. Unlike the typical imager 10 (described above with reference to FIG. 3), the column decoder 118 of the illustrated embodiment provides only column select signals, such as column 0 select signal colse10, column 1 select signal colse11, etc. That is, the column decoder 118 does not have to generate column select signals associated with a pixel color, such as the column 0 green pixel select signal colse10_g, column 0 red/blue select signal colse10_rb, column 1 green pixel select signal colse11_g, and a column 1 red/blue select signal colse11_rb (FIG. 3).

The column 0 S/H sub-circuit 130₀ comprises a biasing transistor 32₀, controlled by a control voltage Vln, that is used to bias its respective pixel output line pixout0. The pixel 0 output line pixout0 is also connected to a first capacitor 42₀ thru a sample and hold pixel signal switch 34₀. The sample and hold pixel signal switch 34₀ is controlled by the sample and hold pixel control signal SHS. In addition, the pixel 0 output line pixout0 is connected to a second capacitor 44₀ thru a sample and hold reset signal switch 36₀. The sample and hold reset signal switch 36₀ is controlled by the sample and hold reset control signal SHR. In a desired embodiment, the switches 34₀, 36₀ are MOSFET transistors. It should be appreciated that the invention may use any suitable controllable switching device as the switches 34₀, 36₀, and that the invention is not limited to MOSFET transistors.

A second terminal of the first capacitor 42₀ is connected to the first green pixel output line 70 via a first column select switch 150₀, which is controlled by the column 0 select signal colse10. The second terminal of the first capacitor 42₀ is also connected to a clamping voltage VCL via a first clamping switch 60₀. A second terminal of the second capacitor 44₀ is connected to the second green pixel output line 72 via a second column select switch 152₀, which is also controlled by the column 0 select signal colse10. The second terminal of the second capacitor 44₀ is also connected to the clamping voltage VCL via a second clamping switch 62₀.

As is known in the art, the clamping voltage VCL is used to place a charge on the two capacitors 42₀, 44₀ when it is desired to store the pixel and reset signals, respectively input from the array 20 (when the appropriate S/H control signals SHS, SHR are also generated).

Connected between the connection of the first capacitor 42₀ and its sample and hold switch 34₀ and the connection of the second capacitor 44₀ and its sample and hold switch 36₀ is a crowbar switch 40₀. The crowbar switch 40₀ is controlled by the CBse10 output from the AND gate 38₀. During readout of column 0, the column 0 S/H circuit 130₀ is selected by the colse10 signal, the global crowbar control signal CB is also generated, which causes the CBse10 signal to be output from the AND gate 38₀. As such, crowbar switch 40₀ is closed, which shorts the front plates of the two capacitors 42₀, 44₀, driving the respective charges on these capacitors 42₀, 44₀ out to the column select switched 150₀, 152₀.

Similar to the column 0 S/H sub-circuit 130₀, the global crowbar control signal CB is input into an AND gate 38₁ of the column 1 S/H sub-circuit 30₁. The second input of the AND gate 38₁ is connected to the column 1 select signal colse11. The output of the AND gate 38₁ is a crowbar control/select column 1 signal CBsell, which is generated only when the colse11 and CB signals are activated at the same time. The remainder of the column 1 S/H sub-circuit 130₁ is essentially the same as the column 0 S/H sub-circuit 130₀. Thus, no further description of the column 1 S/H sub-circuit 130₁ is required.

Referring to FIGS. 2 and 4, in operation, the signals from Row0 are sampled onto the S/H circuitry 130 first. This means that the even row signal EVEN_ROW is generated and closes the first and fourth input switches 182, 188 of the multiplexer 180. The odd row signal ODD_ROW is not generated and thus, the second and third input switches 184, 186 remain open. As such, even numbered column S/H circuitry (e.g., sub-circuit 130₀) samples the signals from the even numbered columns (e.g., Co10), which for even rows are the green pixels 22 (Gr). Odd numbered column S/H circuitry (e.g., sub-circuit 130₁) samples the signals from the odd numbered columns (e.g., Co11), which for even rows are the red pixels 24 (R).

Due to the multiplexer 180 at the entrance of the column S/H circuitry 130, pixel signals from the Row0 green pixels 22 go to line 70 of the first channel Chg through the first column select switch 150₀ of the column 0 S/H sub-circuit 130₀. Reset signals from the Row0 green pixels 22 go to line 72 of the first channel Chg through the second column select switch 152₀ of the column 0 S/H sub-circuit 130₀. The pixel signals from the Row0 red pixels 24 go to line 74 of the second channel Chrb through the first column select switch 150₁ of the column 1 S/H sub-circuit 130₁. Reset signals from the Row0 red pixels 24 go to line 76 of the second channel Chrb through the second column select switch 1521 of the column 1 S/H sub-circuit 130₁.

For odd rows, such as Row1, blue 26 and green 28 pixels are sampled by the S/H circuitry 130. This means that the odd row signal ODD_ROW is generated and closes the second and third input switches 184, 186 of the multiplexer 180. The even row signal EVEN_ROW is not generated and thus, the first and fourth input switches 182, 188 remain open. As such, odd numbered column S/H circuitry (e.g., sub-circuit 130₁) samples the signals from the even numbered columns (e.g., Co10), which for odd rows are the blue pixels 26 (B). Even numbered column S/H circuitry (e.g., sub-circuit 130₀) samples the signals from the odd numbered columns (e.g., Co11), which for odd rows are the green pixels 28 (Gr).

Due to the multiplexer 180 at the entrance of the column S/H circuitry 130, pixel signals from the Row1 green pixels 28 go to line 70 of the first channel Chg through the first column select switch 150₀ of the column 0 S/H sub-circuit 130₀. Reset signals from the Row1 green pixels 22 go to line 72 of the first channel Chg through the second column select switch 152₀ of the column 0 S/H sub-circuit 130₀. The pixel signals from the Row1 blue pixels 26 go to line 74 of the second channel Chrb through the first column select switch 150₁ of the column 1 S/H sub-circuit 130₁. Reset signals from the Row1 blue pixels 24 go to line 76 of the second channel Chrb through the second column select switch 152₁ of the column 1 S/H sub-circuit 130₁.

With the architecture illustrated in FIG. 4, the imager 110 of the invention achieves several benefits over the typical imager 10 illustrated in FIG. 3. For example, the imager 110 uses simplified column select circuitry; the imager 110 uses less transistors at the readout path, which means that less layout space is used. This is beneficial because the column pitch is reduced. The imager 110 also achieves much faster readout speeds since parasitic capacitance on the readout path is reduced. The imager 110 achieves lower readout noise and less power consumption. The reduction is parasitic capacitance means a higher feedback factor, which leads to lower readout noise. Higher feedback factor also reduces the gain bandwidth (GBW) requirement of the amplifier. As such, a slower amplifier may be used, which in turn lowers the power consumption of the imager 110.

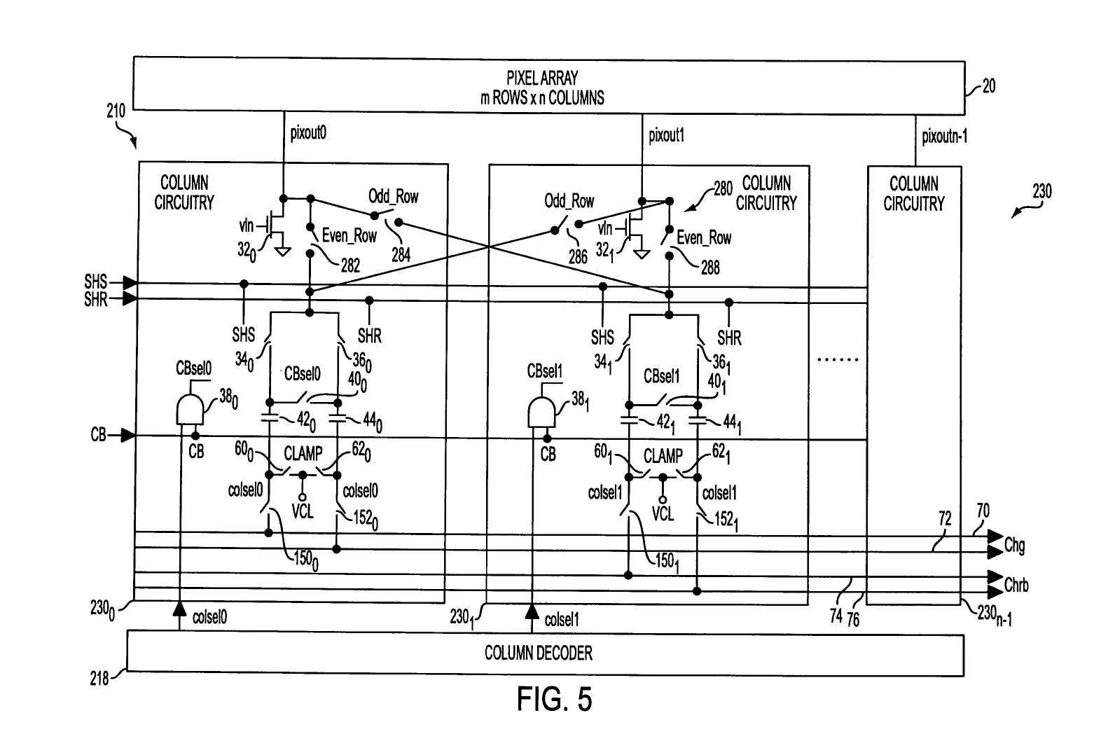

FIG. 5 shows a CMOS imager 210 constructed in accordance with a second exemplary embodiment of the invention. The imager 210 includes a pixel array 20, column decoder 218, column S/H circuitry 230, multiplexer 280 and two output channels Chg, Chrb. The illustrated imager 210 is substantially the same as the imager 110 described above with reference to FIG. 4.

In this embodiment, the multiplexer circuitry 280, comprised of four input switches 282, 284, 286, 288, is included within, instead of being separate from, the column S/H circuitry 230. That is, each even numbered column sub-circuit (e.g., sub-circuit 230₀) contains the first and second input switches 282, 284, while each odd numbered column sub-circuit (e.g., sub-circuit 230₁) contains the third and fourth input switches 286, 288. The first and fourth input switches 282, 288 are controlled by the even row control signal EVEN_ROW as described above with reference to the first and fourth input switches 182, 188 of FIG. 4. The second and third input switches 284, 286 are controlled by the odd row control signal ODD_ROW as described above with reference to the second and third input switches 184, 186 of FIG. 4.

Other than the above-described differences, the FIG. 5 imager 210 operates in the same manner as the FIG. 4 imager 110. The illustrated imager 210 also achieves the same benefits as the FIG. 4 imager 110.

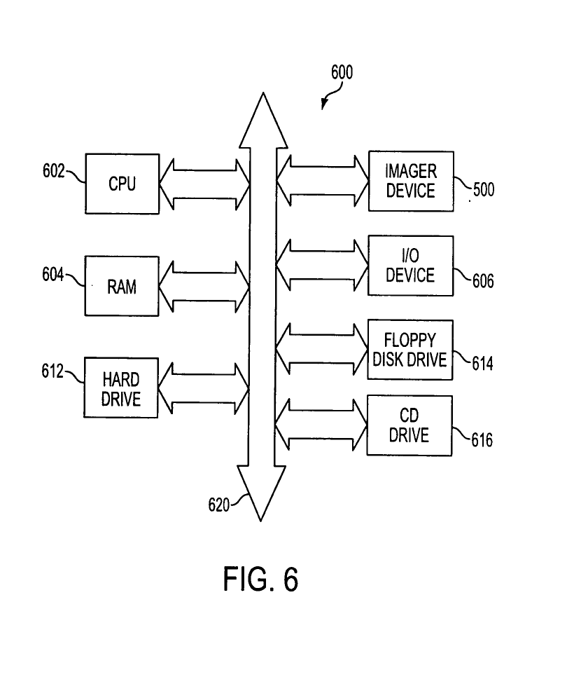

FIG. 6 shows system 600, a typical processor based system modified to include an imager device 500 constructed in accordance with an embodiment of the invention. That is, imager device 500 may be the devices 110, 210 described above with reference to FIGS. 4 and 5. Examples of processor based systems, which may employ the imager device 500, include, without limitation, computer systems, camera systems, scanners, machine vision systems, vehicle navigation systems, video telephones, surveillance systems, auto focus systems, star tracker systems, motion detection systems, image stabilization systems, and others.

System 600 includes a central processing unit (CPU) 602 that communicates with various devices over a bus 620. Some of the devices connected to the bus 620 provide communication into and out of the system 600, illustratively including an input/output (I/O) device 606 and imager device 500. Other devices connected to the bus 620 provide memory, illustratively including a random access memory (RAM) 604, hard drive 612, and one or more peripheral memory devices such as a floppy disk drive 614 and compact disk (CD) drive 616. The imager device 500 may be combined with a processor, such as a CPU, digital signal processor, or microprocessor, in a single integrated circuit.

The present invention has been illustrated as having two output channels Chg, Chrb. It should be appreciated that the present invention may be used with imagers having more than two channels. All that would be required is for the input multiplexer 180, 280 to be connected to more columns and column S/H circuitry to accommodate the extra channels. In addition, the present invention may be used with black and white imagers having two or more output channels. In black and white imagers, the present invention would provide increased speed, due to the reduced parasitic capacitance at the readout path as well as the other benefits discussed above with reference to FIG. 4.

The present invention has been illustrated as having the first output channel as the channel reading out signals from green pixels and the second output channel as reading out signals from the red and blue pixels. It should be appreciated that the first output channel could be used to read out signals from the red and blue pixels while and the second output channel could be used to read out signals from the green pixels. The signals used by the present invention (e.g., EVEN_ROW, ODD_ROW, CB, SHS, SHR, etc.) may be generated by a controller such as the timing and control circuit disclosed in U.S. Pat. No. 6,140,630, an image processor or any controller or control logic suitable for operating an imager device.

The present invention has been illustrated as showing the pixels of two columns (e.g., Co10, Co11) connected to two sample and hold sub-circuits (e.g., 130₀, 130₁). The manner in which the two columns (e.g., Co10, Co11) are connected to the two sample and hold sub-circuits (e.g., 130₀, 130₁) is dependent upon the mode of operation of the imager. That is, in a first exemplary mode of operation, even numbered rows are read out, which causes the multiplexer (e.g., 180) of the invention to connect the two columns (e.g., Co10, Co11) to the two sample and hold sub-circuits (e.g., 130₀, 130₁) in one manner. In a second exemplary mode of operation, odd numbered rows are read out, which causes the multiplexer 180 of the invention to connect the two columns (e.g., Co10, Co11) to the two sample and hold sub-circuits (e.g., 130₀, 130₁) in a second different manner. It should be appreciated, however, that the invention can be extended to any number N of column and any number Y of sample and hold sub-circuits such that the multiplexer (e.g., 180, 280) operates to connect any of the N columns to any of the M S/H sub-circuits in a first mode of operation, and any other, or combination, of the N columns to any other of the M S/H sub-circuits in a second different mode of operation.

The processes and devices described above illustrate preferred methods and typical devices of many that could be used and produced. The above description and drawings illustrate embodiments, which achieve the objects, features, and advantages of the present invention. However, it is not intended that the present invention be strictly limited to the above-described and illustrated embodiments. Any modification, though presently unforeseeable, of the present invention that comes within the spirit and scope of the following claims should be considered part of the present invention.

1. An imager device comprising:
a plurality of pixels arranged in at least a first and second column, each column having a column line to which pixels in the column can be connected;
first and second sample and hold circuits for sampling and holding signals output from the pixels on said column lines; and
a multiplexer coupling at least first and second column lines with said first and second sample and hold circuits and being operable, in a first mode, to respectively couple said first and second sample and hold circuits to said first and second column lines and being operable, in a second mode, to respectively couple said first and second sample and hold circuits to said second and first column lines.

2. The imager device of claim 1, wherein the plurality of pixels comprises an array of complementary metal oxide semiconductor pixels.

3. The imager device of claim 1, wherein said multiplexer is controlled such that signals associated with a first pixel type are sampled and held by said first sample and hold circuit and signals of a pixel type different than the first pixel type are sampled and held by said second sample and hold circuit.

4. The imager device of claim 3, wherein the first pixel type is a first pixel color and the pixel type other than the first pixel type is at least a second pixel color.

5. The imager device of claim 3, wherein the first pixel type is a first pixel color and the pixel type other than the first pixel type comprises second and third pixel colors.

6. The imager device of claim 1 further comprising a column decoder connected to and supplying control signals to said sample and hold circuits, said column decoder controlling said sample and hold circuits such that signals associated with a first pixel type are output on a first output channel and signals of a pixel type different than the first pixel type are output on a second output channel.

7. The imager device of claim 6, wherein the first output channel comprises two output lines and the second output channel comprises two output lines.

8. The imager device of claim 7, wherein said first sample and hold circuit samples and holds reset and pixel signals associated with the first pixel type, the pixel signals being output on one output line of the first output channel and the reset signals being output on a second output line of the first output channel.

9. The imager device of claim 7, wherein said second sample and hold circuit samples and holds reset and pixel signals associated with the pixel type that is different than the first pixel type, the pixel signals being output on one output line of the second output channel and the reset signals being output on a second output line of the second output channel.

10. The imager device of claim 1, wherein said multiplexer comprises a plurality of switching circuits.

11. The imager device of claim 10, wherein said switching circuits reside between the pixels and sample and hold circuits.

12. The imager device of claim 10, wherein said switching circuits reside in an input portion of the sample and hold circuits.

13. The imager device of claim 10, wherein said switching circuits comprise one switching configuration when a row being read is an even numbered row and a second switching configuration when a row being read is an odd numbered row.

14. An image device comprising:
a plurality of pixel signals arranged in N columns, each column having a respective column line to which the pixels in the column can be connected;
a plurality Y of sample and hold circuits for sampling and holding signals output from said pixels; and
a multiplexing circuit for coupling, in one operating mode, one of said N column lines to one of said sample and hold circuits and, in another operating mode, coupling a different one of said N columns to said one sample and hold circuit.

15. The imager device of claim 14, wherein each of said M sample and hold circuits comprise respective output lines.

16. The imager device of claim 14, wherein the first operating mode is a readout operation in which even numbered rows of pixels are being read and the another operating mode is a readout operation in which odd numbered rows of pixels are being read.

17. An imager device comprising:
an array of pixels arranged in a plurality of rows and columns, each even numbered row having alternating green and red pixels, each odd numbered row having alternating blue and green pixels;
a plurality of first sample and hold circuits, each first sample and hold circuit being connected to a respective even numbered column of said array;
a plurality of second sample and hold circuits, each second sample and hold circuit being connected to a respective odd numbered column of said array; and
a plurality of switching circuits, each switching circuit being associated with and connected to a respective first sample and hold circuit and its associated even numbered column and a respective second sample and hold circuit and its associated odd numbered column, wherein said switching circuits being controlled such that signals associated with green pixels are sampled and held by said first sample and hold circuits and signals associated with the red and blue pixels are sampled and held by said second sample and hold circuits.

18. The imager device of claim 17, wherein the array of pixels comprises an array of complementary metal oxide semiconductor pixels.

19. The imager device of claim 17, further comprising a column decoder connected to and supplying control signals to said sample and hold circuits, said column decoder controlling said sample and hold circuits such that signals associated with the green pixels are output on a first output channel and signals associated with the red and blue pixels are output on a second output channel.

20. The imager device of claim 19, wherein the first output channel comprises two output lines and the second output channel comprises two output lines.

21. The imager device of claim 20, wherein said first sample and hold circuits sample and hold reset and pixel signals associated with the green pixels, the pixel signals being output on one output line of the first output channel and the reset signals being output on a second output line of the first output channel.

22. The imager device of claim 20, wherein said second sample and hold circuits sample and hold reset and pixel signals associated with the red and blue pixels, the pixel signals being output on one output line of the second output channel and the reset signals being output on a second output line of the second output channel.

23. The imager device of claim 17, wherein said switching circuits reside between the array and sample and hold circuits.

24. The imager device of claim 17, wherein said switching circuits reside in an input portion of the sample and hold circuits.

25. The imager device of claim 17, wherein said switching circuits comprise one switching configuration when a row being read is an even numbered row and a second switching configuration when a row being read is an odd numbered row.

26. The imager device of claim 17, wherein each switching circuit comprises:
a first input switch coupled between a pixel line from the even numbered column and a first charge storage device;
a second input switch coupled between the connection of the first input switch and a third input switch;
said third input switch being coupled between the connection of the third input switch and a fourth input switch; and
said fourth input switch being coupled between a pixel line from the odd numbered column and a second charge storage device.

27. The imager device of claim 26, wherein said first and fourth switches are closed when a row being read is an even numbered row.

28. The imager device of claim 26, wherein said second and third switches are closed when a row being read is an odd numbered row.

29. A processor system comprising:
an imager device comprising:
an array of pixels arranged in a plurality of rows and columns;
a plurality of first sample and hold circuits, each first sample and hold circuit being connected to a respective even numbered column of said array;
a plurality of second sample and hold circuits, each second sample and hold circuit being connected to a respective odd numbered column of said array; and
a multiplexer comprising a plurality of switching circuits, each switching circuit being associated with and connected to a respective first sample and hold circuit and its associated even numbered column and a respective second sample and hold circuit and its associated odd numbered column,
wherein said switching circuits are controlled such that signals associated with a first pixel type are sampled and held by said first sample and hold circuits and signals of a pixel type different than the first pixel type are sampled and held by said second sample and hold circuits.

30. The system of claim 29, wherein the array of pixels comprises an array of complementary metal oxide semiconductor pixels.

31. The system of claim 29, wherein the pixels of the first pixel type reside in even numbered and odd numbered columns.

32. The system of claim 31, wherein the pixels of the pixel type other than the first pixel type reside in even numbered and odd numbered columns.

33. The system of claim 29, wherein the first pixel type is a first pixel color and the pixel type other than the first pixel type is at least a second pixel color.

34. The system of claim 29, wherein the first pixel type is a first pixel color and the pixel type other than the first pixel type comprises second and third pixel colors.

35. The system of claim 29 further comprising a column decoder connected to and supplying control signals to said sample and hold circuits, said column decoder controlling said sample and hold circuits such that signals associated with the first pixel type are output on a first output channel and signals of a pixel type different than the first pixel type are output on a second output channel.

36. The system of claim 35, wherein the first output channel comprises two output lines and the second output channel comprises two output lines.

37. The system of claim 36, wherein said first sample and hold circuits sample and hold reset and pixel signals associated with the first pixel type, the pixel signals being output on one output line of the first output channel and the reset signals being output on a second output line of the first output channel.

38. The system of claim 36, wherein said second sample and hold circuits sample and hold reset and pixel signals associated with the pixel type that is different than the first pixels type, the pixel signals being output on one output line of the second output channel and the reset signals being output on a second output line of the second output channel.

39. The system of claim 29, wherein said switching circuits reside between the array and sample and hold circuits.

40. The system of claim 29, wherein said switching circuits reside in an input portion of the sample and hold circuits.

41. The system of claim 29, wherein said switching circuits comprise one switching configuration when a row being read is an even numbered row and a second switching configuration when a row being read is an odd numbered row.

42. The system of claim 29, wherein each switching circuit comprises:
a first input switch coupled between a pixel line from the even numbered column and a first charge storage device;
a second input switch coupled between the connection of the first input switch and a third input switch;
said third input switch being coupled between the connection of the third input switch and a fourth input switch; and
said fourth input switch being coupled between a pixel line from the odd numbered column and a second charge storage device.

43. The system of claim 42, wherein said first and fourth switches are closed when a row being read is an even numbered row.

44. The system of claim 42, wherein said second and third switches are closed when a row being read is an odd numbered row.

45. A processor system comprising:
an imager device, comprising:
an array of pixels arranged in a plurality of rows and columns, each even numbered row having alternating green and red pixels, each odd numbered row having alternating blue and green pixels;
a plurality of first sample and hold circuits, each first sample and hold circuit being connected to a respective even numbered column of said array;
a plurality of second sample and hold circuits, each second sample and hold circuit being connected to a respective odd numbered column of said array; and
a plurality of switching circuits, each switching circuit being associated with and connected to a respective first sample and hold circuit and its associated even numbered column and a respective second sample and hold circuit and its associated odd numbered column, wherein said switching circuits being controlled such that signals associated with green pixels are sampled and held by said first sample and hold circuits and signals associated with the red and blue pixels are sampled and held by said second sample and hold circuits.

46. The system of claim 45, wherein the array of pixels comprises an array of complementary metal oxide semiconductor pixels.

47. The system of claim 45, further comprising a column decoder connected to and supplying control signals to said sample and hold circuits, said column decoder controlling said sample and hold circuits such that signals associated with the green pixels are output on a first output channel and signals associated with the red and blue pixels are output on a second output channel.

48. The system of claim 47, wherein the first output channel comprises two output lines and the second output channel comprises two output lines.

49. The system of claim 48, wherein said first sample and hold circuits sample and hold reset and pixel signals associated with the green pixels, the pixel signals being output on one output line of the first output channel and the reset signals being output on a second output line of the first output channel.

50. The system of claim 48, wherein said second sample and hold circuits sample and hold reset and pixel signals associated with the red and blue pixels, the pixel signals being output on one output line of the second output channel and the reset signals being output on a second output line of the second output channel.

51. The system of claim 45, wherein said switching circuits reside between the array and sample and hold circuits.

52. The system of claim 45, wherein said switching circuits reside in an input portion of the sample and hold circuits.

53. The system of claim 45, wherein said switching circuits comprise one switching configuration when a row being read is an even numbered row and a second switching configuration when a row being read is an odd numbered row.

54. The system of claim 45, wherein each switching circuit comprises:
a first input switch coupled between a pixel line from the even numbered column and a first charge storage device;
a second input switch coupled between the connection of the first input switch and a third input switch;
said third input switch being coupled between the connection of the third input switch and a fourth input switch; and
said fourth input switch being coupled between a pixel line from the odd numbered column and a second charge storage device.

55. The system of claim 54, wherein said first and fourth switches are closed when a row being read is an even numbered row.

56. The system of claim 54, wherein said first and fourth switches are closed when a row being read is an even numbered row.

57. A processor system comprising:
an imager device, said imager device comprising:
a plurality of pixel signals arranged in N columns, each column having a respective column line to which the pixels in the column can be connected;
a plurality Y of sample and hold circuits for sampling and holding signals output from said pixels; and
a multiplexing circuit for coupling, in one operating mode, one of said N column lines to one of said sample and hold circuits and, in another operating mode, coupling a different one of said N columns to said one sample and hold circuit.

58. A method of operating an imager device, said method comprising the steps of:
storing signals associated with a first pixel type in a first storage device associated with a first column of pixels;
storing signals associated with a type other than the first pixel type in a second storage device associated with a second column of pixels;
outputting the signals from the first storage device to a first channel; and
outputting the signals from the second storage device to a second channel.

59. The method of claim 58 wherein said step of storing signals associated with the first pixel type comprises:
determining whether a row being read is even; and
if it is determined that the row is even, storing a signal received from a first column in the first storage device.

60. The method of claim 59, wherein said step of storing signals associated with the first pixel type further comprises:
connecting the first storage device to a second column if it is determined that the row is odd; and
storing a signal received from the second column in the first storage device.

61. The method of claim 58, wherein said step of storing signals associated with a pixel type other than the first pixel type comprises:
determining whether a row being read is even; and
if it is determined that the row is even, storing a signal received from a first column in the second storage device.

62. The method of claim 61, wherein said step of storing signals associated with a pixel type other than the first pixel type further comprises:
connecting the second storage device to a second column if it is determined that the row is even; and
storing a signal received from the second column in the second storage device.

63. A method of operating a CMOS color imager device, said method comprising the steps of:
storing signals associated with green pixels in a first storage device associated with a first column of pixels; and
storing signals associated with red and blue pixels in a second storage device associated with a second column of pixels.

64. The method of claim 63 further comprising the steps of:
outputting the signals from the first storage device to a first channel; and
outputting the signals from the second storage device to a second channel.

65. The method of claim 63, wherein said step of storing signals associated with green pixels comprises:
determining whether a row being read is even; and
if it is determined that the row is even, storing a signal received from a first column in the first storage device.

66. The method of claim 65, wherein said step of storing signals associated with the green pixels further comprises:
connecting the first storage device to a second column if it is determined that the row is odd; and
storing a signal received from the second column in the first storage device.

67. The method of claim 63, wherein said step of storing signals associated with the red and blue pixels comprises:
determining whether a row being read is even; and
if it is determined that the row is even, storing a signal received from a first column in the second storage device.

68. The method of claim 67, wherein said step of storing signals associated with the red and blue pixels further comprises:
connecting the second storage device to a second column if it is determined that the row is even; and
storing a signal received from the second column in the second storage device.
